(19) United States
(12) Patent Application Publication
(10) Pub. No.: US 2020/0224609 A1
(43) Pub. Date: Jul. 16, 2020

(54) DEVICE FOR INJECTING WATER INTO AN INTERNAL COMBUSTION ENGINE

(71) Applicant: Vitesco Technologies GmbH, Hannover (DE)

(72) Inventors: Jan Hodgson, Troisdorf (DE); Ewald Renner, Waldaschaff (DE); Marc Völker, Magdeburg (DE); Joerg Walter, Seeheim-Jugenheim (DE)

(21) Appl. No.: 16/632,978

(22) PCT Filed: Jun. 27, 2018
(86) PCT No.: PCT/EP2018/067285

§ 371 Date: Jan. 22, 2020

(30) Foreign Application Priority Data
Jul. 24, 2017 (DE) 10 2017 212 687.6

(51) Int. Cl. F02M 25/028; C02F 1/32; C02F 1/50

(52) U.S. Cl. CPC F02M 25/028; C02F 1/505; C02F 1/32

(57) ABSTRACT

A device for injecting water into an internal combustion having a tank for storage and provision of water, an injector for injecting the water into the internal combustion engine, which injector is connected to the tank, a control unit for controlling the injector 6, and a decontamination unit which has at least one element with a contact surface which, with formation of a surface contact with the water, acts in a decontaminating manner to provide decontaminated water for injection.

### CROSS REFERENCE TO RELATED APPLICATIONS

This is a U.S. national stage of Application No. PCT/EP2018/067285 filed Jun. 27, 2018. Priority is claimed on German Application No. DE 10 2017 212 687.6 filed Jul. 24, 2017 the content of which is incorporated herein by reference.

### BACKGROUND OF THE INVENTION

### 1. Field of the Invention

The invention relates to a device for injecting water into an internal combustion engine.

### 2. Description of Related Art

Due to increasing demands on reduced carbon dioxide emissions, internal combustion engines are increasingly being optimized with regard to their fuel consumption. However, known internal combustion engines can not be optimally operated in terms of consumption at operating points with high load, since the operation is limited by knock tendency and high exhaust gas temperatures. A possible measure for reducing the knock tendency and for lowering the exhaust gas temperatures is the injection of water. Separate water injection systems are customarily present here to allow the water injection. Thus, for example, WO 2014/080266 A1 discloses a water injection system for an internal combustion engine with exhaust gas recirculation, in which system the water is injected into the mass flow of the exhaust gas recirculation.

A known problem with water injection systems is a possible impairment of their function by contamination, which can be caused by impurities in the water used. These impurities promote the formation of algae and fungi and also the growth of cyanobacteria, acetobacter, or other microorganisms. The contamination or biocontamination arises in particular in the water tank with long-standing medium. To avoid contamination or to eliminate already existing contamination, chemical products or coatings are used in known water injection systems. However, this can lead to a malfunction of the components right up to failure and to clogging of filters which are arranged in the water injection system.

### SUMMARY OF THE INVENTION

An object of one aspect of the invention is counteracting of such water contamination.

One aspect of the invention is a device for injecting water into an internal combustion engine.

What is proposed is a device for injecting water into an internal combustion engine, comprising:

a tank for storage and provision of water, at least one injector for injecting the water into the internal combustion engine, which injector is connected to the tank, a control unit for controlling the injector, and a decontamination unit.

Here, the decontamination unit has at least one element with a contact surface which, with formation of a surface contact with the water, acts in a decontaminating manner to provide decontaminated water for injection.

The proposed water injection device counteracts the contamination of the water mentioned at the outset without having to resort to chemical additives. Rather, the decontamination action described here is based on the chemical properties and the antibacterial action of a material forming the contact surface, such as silver, for example, which kills bacteria and fungi. Silver is known to have an antibacterial action in that the silver ions attach themselves to the bacteria and fungi and thus block their respiration and metabolism. They die as a result.

According to one aspect of the present invention, the decontamination unit comprises at least one element formed from a decontaminating material and at the same time forms the contact surface.

According to a further aspect of the present invention, the decontamination unit can additionally or alternatively comprise at least one element with a contact surface provided by a decontaminating material coating on a carrier material.

The element can here be designed as a plate and/or as a ring that forms the contact surface.

Additionally or alternatively, there can also be provided an element designed as a line or as a line section that forms the decontaminating contact surface.

Additionally or alternatively, there can also be provided an element designed as a line or as a line section that comprises a grid arranged transversely with respect to the throughflow direction of the line or of the line section and which forms the decontaminating contact surface.

Here, the decontamination unit can comprise, for example, the aforementioned tank, which as such can form the contact surface at least in certain portions. Here, the tank itself can be formed, for example, from plastic and be provided on the side facing the water with a silver coating, for example.

Alternatively or additionally, the decontamination unit can further comprise a delivery module for delivering the water, which delivery module forms the at least one contact surface. Here, the delivery module comprises a pump stage and an electric motor that drives the pump stage.

Alternatively or additionally, the decontamination unit can further have at least one filter element that comprises a decontaminating filter material.

According to a further aspect of the present invention, the at least one contact surface can be configured, with formation of the surface contact with the water, to release a colloidal substance. Such a colloidal substance can be, for example, a very specific form of silver particles. These are extremely tiny particles of silver which are bound in water but not dissolved. In order to produce these tiny constituents, the silver is comminuted by various processes, for example in corresponding colloid mills or by chemical processes. Colloidal silver acts against bacteria or fungi.

To form the at least one contact surface, it is proposed here to use the metals silver, copper, and/or brass. Alternatively or additionally, other materials can also be used that are suitable for the decontamination of water.

According to a further aspect of the present invention, the above-proposed decontamination can be assisted by application of ultraviolet radiation. For this purpose, the decontamination unit can comprise at least one UV lamp for irradiating the water with UV light, which UV lamp can be controlled via the control unit. Here, the UV lamp can be mounted at various points of the water injection device, for instance in and/or outside the tank.

### BRIEF DESCRIPTION OF THE DRAWINGS

Exemplary embodiments of the invention will be described in detail below with reference to the accompanying drawing, with identical or functionally identical parts each being designated by the same reference sign. In the drawing:

FIG. 1 is a highly simplified schematic view of an internal combustion engine having a device for injecting water;

FIG. 2 is a simplified schematic view of the device according to FIG. 1;

FIG. 3 is a highly simplified schematic view of the device; and

FIG. 4 is a highly simplified schematic view of the device.

### DETAILED DESCRIPTION OF THE PRESENTLY PREFERRED EMBODIMENTS

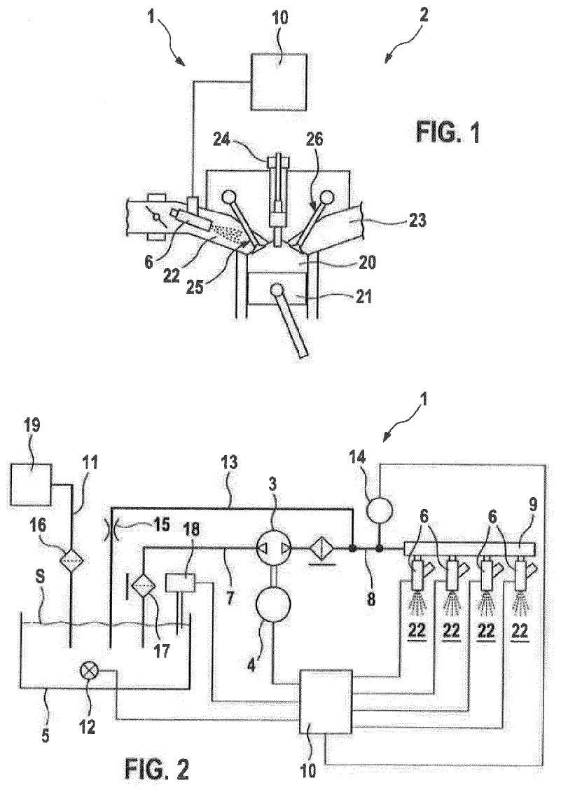

A device 1 for injecting water into an internal combustion engine 2 according to a first aspect of the invention will be described in detail below with reference to FIG. 1 and FIG. 2. In particular, the internal combustion engine 2 is operated according to the Otto principle and with gasoline direct injection.

FIG. 1 schematically illustrates the internal combustion engine 2, which has a plurality of cylinders. The internal combustion engine 2 comprises, for each cylinder, a combustion chamber 20 in which a piston 21 is movable back and forth. Furthermore, the internal combustion engine 2 preferably has per cylinder an inlet port 22 via which air is supplied to the combustion chamber 20 per cylinder. Exhaust gas is removed via an exhaust gas port 23. For this purpose, an inlet valve 25 is arranged at the inlet port 22, and an outlet valve 26 is arranged at the exhaust gas port 23. Furthermore, the reference sign 24 designates a fuel injection valve.

Also arranged at the inlet port 22 is a water injector 6 that injects water into the inlet port 22 of the internal combustion engine 2 via a control unit 10. In this exemplary embodiment, one water injector 6 per cylinder is provided. Alternatively, one water injector per inlet valve can be arranged for better processing or to increase the maximum injectable amount of water per combustion cycle.

FIG. 2 shows the device 1 according to one aspect of the invention for injecting water. The water injection device 1 comprises a delivery element 3 designed as a pump and an electric drive 4 for driving the pump 3. Furthermore, there is provided a water tank 5 connected to the pump 3 by a first line 7. A second line 8 connects the pump 3 to a distributor 9 or a rail, to which a plurality of water injectors 6 are connected.

To inject water, the water is supplied from the water tank 5 by the pump 3 into the water injectors 6. For this, a condensate of an air-conditioning unit 19 is preferably used, for which purpose the device 1 according to the invention for the injection of water has a filling line 11.

Alternatively or in addition to the condensate, deionized water can be conveyed from a refill tank (not shown) into the water tank 5. A first filter element 16 is arranged in the filling line 11, and a second filter element 17 is arranged in the first line 7.

To set the desired system pressure in the distributor 9, a pressure regulator 15 in the form of an orifice plate is arranged in a return line 13 that connects the second line 8 to the water tank 5. Alternatively, the pressure regulator 15 can be designed as a nonreturn valve. For pressure regulation, a pressure sensor 14 is further provided in the second line 8.

The water tank 5 is illustrated in FIG. 2 with water at a maximum water level S. A UV lamp 12 is arranged according to one aspect of the invention within the water tank 5. The UV lamp 12 is configured to emit ultraviolet radiation and is activated via the control unit 10 in order to decontaminate the water in the water tank 5. The UV lamp 12 is activated periodically at predetermined intervals in this exemplary embodiment. Alternatively, the UV lamp 12 can be operated permanently (continuously) to ensure that no contamination occurs in the water tank 5.

Furthermore, the UV lamp 12 is arranged so as to be adjustable in the water tank 5. Thus, depending on the application, the UV lamp 12 can be positioned in such a way that optimal decontamination of the water takes place.

Furthermore, a filling level sensor 18 is provided in the device 1. The filling level sensor 18 serves to detect a water filling level of the water tank 5. The detected water filling level can serve to control the UV lamp 12. Thus, for example, a time and/or the duration of the activation of the UV lamp 12 can be determined based on the detected water filling level. In addition, the UV lamp 12 can be adjusted on the basis of the detected water filling level in such a way that the UV lamp 12 is for example always below the current water level in the water tank 5.

The UV lamp 12 allows the water of the water injection device 1 to be disinfected in an ecologically safe and simple manner consequently, clogging of the filter elements 16, 17 can also be avoided, which means that the required amount of water to be injected is available. A failsafe function of the internal combustion engine 2 is thus ensured.

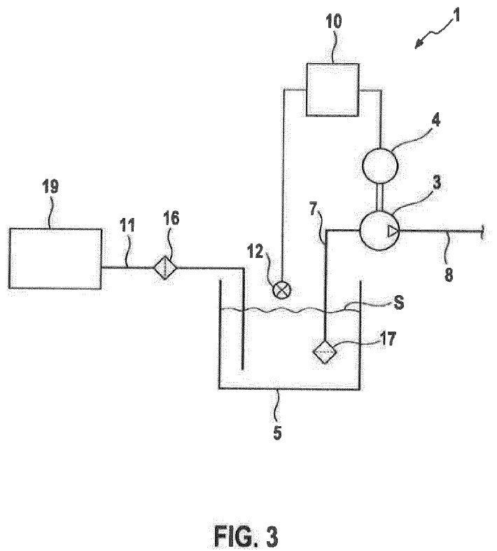

FIG. 3 shows a highly simplified view of the water injection device 1 according to a second exemplary embodiment of the present invention, in which some components of the device 1 have been omitted. The second exemplary embodiment differs from the first exemplary embodiment of FIG. 1 and FIG. 2 basically in that the UV lamp 12 is arranged in the water tank 5 above the maximum water level S. This arrangement offers the advantage of rapid and uniform irradiation of the water in the water tank 5. Since the UV lamp 12 is not sunk in the water, additional costs owing to a complicated sealing of the UV lamp 12 can be avoided.

Furthermore, the second filter element 17 is positioned below the maximum water level S. Thus, the second filter element 17 can be decontaminated by the UV lamp 12.

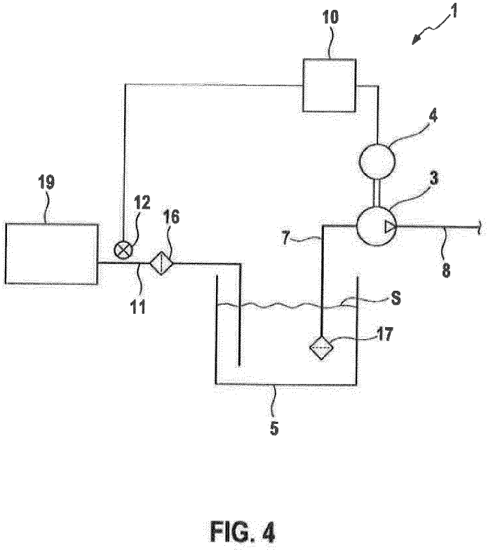

FIG. 4 shows a device 1 for injecting water according to a third exemplary embodiment of the present invention. In this case, the UV lamp 12 is arranged on the filling line 11. The filling line 11 connects the air-conditioning unit 19, in particular an evaporator of the air-conditioning unit 19, to the water tank 5. Furthermore, the UV lamp 12 is preferably arranged upstream of the first filter element 16 in the direction of the supply of water into the water tank 5.

The UV lamp 12 is activated when water condensate from the air-conditioning unit 19 is supplied into the water tank 5. Thus, a targeted decontamination of the water takes place, whereby a cost saving in the operating costs is possible.

Although the water injection device 1 according to the described exemplary embodiments has only one UV lamp 12, it is possible within the scope of the invention to use a plurality of UV lamps, which can be arranged in the lines 7, 8, 11 and 13 and in the water tank 5. This can ensure that the water to be injected is decontaminated at all times. This produces a failsafe function of the internal combustion engine 2.

Additionally or alternatively to the above-described UV irradiation, at least one of the elements of the above-described water injection devices can have, as part of a decontamination unit, a contact surface which, with formation of a surface contact with the water, acts in a decontaminating manner to provide decontaminated water for injection. For this purpose, the element can be formed from a decontaminating material and at the same time form the contact surface. Additionally or alternatively, the element can comprise a contact surface that can be provided by a decontaminating material coating on a carrier material.

This type of decontamination also proceeds entirely without the aid of chemical additives. It is even advantageous over UV irradiation insofar as it does not promote embrittlement of elements of the water injection device that are produced from plastic. Rather, this alternative decontamination action is based on the chemical properties and the antibacterial action of a material forming the contact surface, such as silver, for example, which kills bacteria and fungi.

According to a further embodiment, it is possible, for example, for the above-described lines 7, 8 and/or the tank 5 to be formed as part of a decontamination unit and provide said contact surface for decontamination. Additionally or alternatively, it is possible, for example, for the lines 7, 8 to comprise in their interior a grid arranged transversely with respect to their throughflow direction, the grid forming the decontaminating contact surface and having water flowing around it. The tank 5 can be formed, for example, from plastic and, on the side facing the water, be provided at least in certain portions with, for example, a silver coating in order either to form or to concomitantly form said contact surface.

Alternatively or additionally, the decontamination unit can further comprise the delivery module 3 for delivering the water, which delivery module forms and/or concomitantly forms the at least one contact surface. Here, the delivery module comprises a pump stage and an electric motor which drives the pump stage.

Alternatively or additionally, the decontamination unit can further have for example at least one of the filter elements 16, 17, which can comprise a decontaminating filter material, for instance silver.

To form the at least one contact surface, it is proposed here to use the metals silver, copper, and/or brass. Alternatively or additionally, other materials can also be used which are suitable for the decontamination of water. These can also be metal alloys, such as silver and/or copper alloys, for instance.

In a further alternative embodiment, it is possible, for example, for such a decontaminating element, for instance in the form of a plate, to be arranged within the tank 5 and provide at least one contact surface which can be configured in such a way that, with formation of the surface contact with the water, it releases a colloidal substance. This substance can for example take the form of extremely tiny particles of silver that are bound in water but not dissolved. Such colloidal silver acts against bacteria and fungi.

Although exemplary embodiments have been discussed in the above description, it should be noted that numerous modifications are possible. Furthermore, it should be noted that the exemplary embodiments are merely examples which are not intended to limit the scope of protection, the applications and the structure in any way. Rather, a person skilled in the art will take from the above description a guideline for the implementation of at least one exemplary embodiment, wherein various changes may be made, in particular with regard to the function and arrangement of the described components, without departing from the scope of protection as can be gathered from the claims and equivalent feature combinations.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-12. (canceled)

13. A device configured to inject water into an internal combustion engine, comprising:
a tank configured to store and provide the water;
at least one injector coupled to the tank and configured to inject the water into the internal combustion engine;
a control unit configured to control the at least one injector; and
a decontamination unit having at least one element with at least one contact surface which, with formation of a surface contact with the water, acts in a decontaminating manner to provide decontaminated water for injection.

14. The device as claimed in claim 13, wherein the decontamination unit comprises at least one element formed from a decontaminating material that forms the at least one contact surface.

15. The device as claimed in claim 13, wherein the decontamination unit comprises at least one element with a respective contact surface provided by a decontaminating material coating on a carrier material.

16. The device as claimed in claim 15, wherein the at least one element is designed as a plate and/or as a ring that forms the contact surface.

17. The device as claimed in claim 15, wherein the at least one element is designed as a line or as a line section that forms the at least one contact surface.

18. The device as claimed in claim 15, wherein the at least one element is designed as a line or as a line section that comprises a grid arranged transversely with respect to a throughflow direction of the line or of the line section and that forms the at least one contact surface.

19. The device as claimed in claim 13, wherein the decontamination unit comprises the tank, which forms at least in certain portions the at least one contact surface.

20. The device as claimed in claim 13, wherein the decontamination unit comprises a delivery module configured to deliver the water, wherein the delivery module forms the at least one contact surface.

21. The device as claimed in claim 13, wherein the decontamination unit has at least one filter element that comprises a decontaminating filter material.

22. The device as claimed in claim 13, wherein the at least one contact surface is configured to release a colloidal substance with formation of the surface contact with the water.

23. The device as claimed in claim 13, wherein the at least one contact surface contains at least one of silver, copper, and brass.

24. The device as claimed in claim 13, wherein the decontamination unit comprises at least one UV lamp configured to irradiate the water with UV light, wherein the at least one UV lamp is controlled via the control unit to assist provision of decontaminated water.
